(19) United States
(12) Patent Application Publication
(10) Pub. No.: US 2012/0154981 A1
(43) Pub. Date: Jun. 21, 2012

(54) HYBRID SOLID ELECTROLYTE MEMBRANE, METHOD OF MANUFACTURING THE SAME, AND LITHIUM ION CAPACITOR COMPRISING THE SAME

(75) Inventors: Sangkyun LEE, Gyeonggi-do (KR); Jisung Cho, Gyeonggi-do (KR); Baekyun Kim, Gyeonggi-do (KR)

(73) Assignee: SAMSUNG ELECTRO-MECHANICS CO., LTD.

(21) Appl. No.: 13/045,214

(22) Filed: Mar. 10, 2011

(30) Foreign Application Priority Data
Dec. 16, 2010 (KR) 10-2010-0129227

(51) Int. Cl. H01G 9/155; H01G 9/028

(52) U.S. Cl. 361/502; 252/62.2

(57) ABSTRACT

The present invention provides a hybrid solid electrolyte membrane including a lithium electrolyte salt, an organic polymer, and an inorganic material, and a lithium ion capacitor comprising the same. It is possible to overcome damage of a separator and failure of a capacitor due to deposition of lithium ions on a cathode by using a hybrid solid electrolyte membrane in accordance with the present invention in a lithium ion capacitor. Further, it is possible to simplify manufacturing processes without a pre-doping process. Further, the hybrid solid electrolyte membrane can also perform a role of a separator.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2010-0129227, entitled filed Dec. 16, 2010, which is hereby incorporated by reference in its entirety into this application.”

### BACKGROUND OF THE INVENTION

1. Field of the Invention

The present invention relates to a hybrid solid electrolyte membrane, and a method of manufacturing the same, and a lithium ion capacitor comprising the same, and more particularly, to a hybrid solid electrolyte membrane used in a lithium ion capacitor with high withstand voltage and high energy density, and a method of manufacturing the same and a lithium ion capacitor comprising the same.

2. Description of the Related Art

Since a lithium ion capacitor (LIC) requires a pre-doping process of a cathode active material, it has problems such as high manufacturing cost and difficult manufacturing processes.

Generally, an LIC uses a carbon material, which can intercalate lithium ions, as a cathode active material, but it is more advantageous to use lithium metal or an alloy thereof from an energy density point of view.

However, in case of an LIC using lithium and lithium metal as a cathode active material, needle-like lithium metal (dendrite) is deposited on a cathode due to repeated charge and discharge at the time of use. Therefore, the deposited lithium metal damages a separator so that the LIC is shorted.

As a means of avoiding this defect, an attempt is in progress to prevent leakage of a solution by making an electrolyte into a solid state. It is also considered that solidification of an electrolyte has an effect of suppressing generation of dendrite when using lithium metal and the like in a cathode.

Generally, as an electrolyte of an LIC, aqueous and non-aqueous liquid electrolytes; a gel electrolyte formed by impregnating a polymer electrolyte with an electrolyte solution; and solid electrolytes of inorganic materials such as LiI and Li₃N have been used.

However, in case of the above electrolytes, since they are not enough to solve various problems due to lithium metal deposited on a cathode, a method of solving the problems is needed.

### SUMMARY OF THE INVENTION

The present invention has been invented in order to overcome the above-described problems and it is, therefore, an object of the present invention to provide a solid electrolyte membrane of a lithium ion capacitor capable of improving safety of the capacitor by preventing lithium metal from being deposited on a cathode.

Further, it is another object of the present invention to provide a method of manufacturing a solid electrolyte membrane of a lithium ion capacitor.

Further, it is still another object of the present invention to provide a lithium ion capacitor capable of being manufactured by a simple process without a pre-doping process by including a solid electrolyte membrane.

In accordance with one aspect of the present invention to achieve the object, a solid electrolyte membrane is a hybrid solid electrolyte membrane including a lithium electrolyte salt, an organic polymer, and an inorganic material.

The lithium electrolyte salt may be one or more selected from a group consisting of LiN(CF₃SO₂)₂, LiCF₃SO₃, LiPF₆, LiBF₄, and LiClO₄.

The organic polymer may be one or more selected from a group consisting of oxygen atom-containing polymer compounds having a weight average molecular weight of 100,000 to 5,000,000.

The inorganic material may be an oxide or a sulfide of one or more elements selected from a group consisting of lithium (Li), phosphorus (P), silicon (Si), titanium (Ti), zirconium (Zr), aluminum (Al), calcium (Ca), and magnesium (Mg), or a mixture thereof.

Further, in accordance with another aspect of the present invention to achieve the object, there is provided a method of manufacturing a solid electrolyte membrane including: applying a mixture including a lithium electrolyte salt, an organic polymer, and an inorganic material on one or both surfaces of metal.

The metal may be one or more selected from a group consisting of stainless steel, copper, lithium, nickel, and alloys thereof.

Further, the mixture may include the lithium electrolyte salt 5 to 25 wt %, the organic polymer 35 to 55 wt %, and the inorganic material 30 to 50 wt %.

Further, in accordance with still another aspect of the present invention to achieve the object, there is provided a lithium ion capacitor including: an anode; a cathode; and a hybrid solid electrolyte membrane including a lithium electrolyte salt, an organic polymer, and an inorganic material.

The anode may include activated carbon as an active material.

The cathode may include a material including lithium metal as an active material.

Further, in accordance with still another aspect of the present invention to achieve the object, there is provided a lithium ion capacitor including: an anode including activated carbon as an active material layer; a cathode including a material including lithium metal as an active material layer; and a hybrid solid electrolyte membrane including a lithium electrolyte salt, an organic polymer, and an inorganic material.

In accordance with an embodiment of the present invention, the lithium ion capacitor may not include an additional separator.

In accordance with an embodiment of the present invention, the hybrid solid electrolyte membrane may be used as a separator.

### DETAILED DESCRIPTION OF THE PREFERABLE EMBODIMENTS

Hereinafter, a preferable embodiment of the present invention will be described in detail.

The terms used herein are provided to explain a particular embodiment, not limiting the present invention. As used in this specification, a singular form may include a plural form unless the context clearly indicates otherwise. Further, in the present specification, the terms “comprise” and/or “comprising” specify the existence of shapes, numbers, steps, operations, members, elements, and/or groups thereof, which are referred to, and do not exclude the existence or addition of one or more different shapes, numbers, operations, members, elements, and/or groups thereof.

The present invention relates to a hybrid solid electrolyte membrane, a method of manufacturing the same, and a lithium ion capacitor comprising the same.

The hybrid solid electrolyte membrane in accordance with the present invention is formed by applying a mixture including a lithium salt-containing electrolyte salt, an organic polymer, and an inorganic material on a metal film.

The lithium electrolyte salt may be an electrolyte salt including lithium metal, for a concrete example, one or more selected from a group consisting of LiN(CF₃SO₂)₂, LiCF₃SO₃, LiPF₆, LiBF₄, and LiClO₄.

In an embodiment of the present invention, the organic polymer may be an oxygen atom-containing organic polymer compound, for example, a polyether compound. For example, the polyether compound may be a polyethylene oxide, a polypropylene oxide, polyoxymethylene, or derivatives thereof.

The organic polymer has a weight average molecular weight of 100,000 to 5,000,000, preferably 500,000 to 5,000,000, and most preferably 1,000,000 to 4,000,000. When the weight average molecular weight of the organic polymer is less than 100,000, it may not be preferred due to low oxidation resistance, and when the weight average molecular weight of the organic polymer exceeds 5,000,000, it may not be preferred due to an increase in resistance caused by an increase in density.

Further, the inorganic material included in the hybrid solid electrolyte membrane of the present invention is not particularly limited if it is an oxide or a sulfide of a single element or a mixture thereof or an oxide or a sulfide of two or more elements or a mixture thereof, for example, an oxide or a sulfide of one or more elements selected from a group consisting of lithium (Li), phosphorus (P), silicon (Si), titanium (Ti), zirconium (Zr), aluminum (Al), calcium (Ca), and magnesium (Mg), or a mixture thereof. Among them, a sulfide of one or two or more metals selected from lithium and phosphorus; and an oxide of one or two or more metals selected from silicon, titanium, and zirconium are preferred, but the inorganic material is not limited thereto.

The hybrid solid electrolyte membrane of the present invention uses a mixture of a lithium electrolyte salt 5 to 25 wt %, an organic polymer 35 to 55 wt %, and an inorganic material 30 to 50 wt %, and an applying method of the mixture can use all known methods and is not particularly limited.

Specific examples of the lithium electrolyte salt, the organic polymer, and the inorganic material in the mixture are described above in detail. It may not be preferred due to a decrease in capacity when the content of the lithium electrolyte salt in the mixture is less than 5 wt %. Further, it may not be preferred due to a difficulty in implementing low resistance when the content of the lithium electrolyte salt in the mixture exceeds 25 wt %.

Further, it may not be preferred due to an increase in resistance when the content of the organic polymer in the mixture is less than 35 wt %. Further, it may not be preferred due to a decrease in oxidation resistance when the content of the organic polymer in the mixture exceeds 55 wt %.

Further, it may not be preferred due to a decrease in oxidation resistance when the content of the inorganic material in the mixture is less than 30 wt %. Further, it may not be preferred due to an increase in resistance when the content of the inorganic material in the mixture exceeds 50 wt %.

Further, the present invention is characterized in providing a method of manufacturing a hybrid solid electrolyte membrane including the step of applying a mixture including a lithium electrolyte salt, an organic polymer, and an inorganic material on one or both surfaces of metal.

That is, a hybrid solid electrolyte membrane in accordance with the present invention applies an electrolyte mixture including an electrolyte salt on a surface of metal. At this time, the metal used is one or more selected from a group consisting of stainless steel, lithium, nickel, and alloys thereof.

It may be preferred that a thickness of the electrolyte membrane applied on one or both surfaces of the metal is 30 to 50 μm from a resistance point of view, but the thickness of the electrolyte membrane is not particularly limited.

Meanwhile, the present invention can provide a lithium ion capacitor including the hybrid solid electrolyte membrane manufactured as above.

A lithium ion capacitor in accordance with an embodiment of the present invention may include an anode; a cathode; and a hybrid solid electrolyte membrane including a lithium electrolyte salt, an organic polymer, and an inorganic material.

It may be preferred that the anode uses activated carbon as an active material. It may be preferred that activated carbon in accordance with the present invention has a specific surface area of 800 to 3000 m²/g. A raw material of activated carbon is a coconut shell, a phenol resin, petroleum coke, and so on. It may be preferred that the raw material of activated carbon is activated by a steam activation method, a dissolved KOH activation method, and so on, but an activation method of the raw material of activated carbon is not particularly limited.

Further, it may be preferred that the anode in accordance with the present invention additionally includes a conductive material with the active material to reduce resistance, for example, carbon black or graphite.

Further, in addition to the conductive material, the anode in accordance with the present invention may include a binder such as polyvinylidene fluoride, polyamideimide, or polyimide.

Accordingly, the anode in accordance with the present invention can be obtained by adding the activated carbon as the active material, the conductive material, and the binder into a solvent, mixing them to obtain mixed slurry, and applying the mixed slurry onto an anode current collector.

Even though the solvent is not particularly limited, water, alcohol, and so on may be used as the solvent, and the alcohol may be isopropyl alcohol, ethanol, butanol, pentanol, heptanol, propanol, hexanol, and so on.

The content of each of the active material, the conductive material, and the binder in the mixed slurry may be similar to that included in a general lithium ion capacitor but is not particularly limited.

The anode current collector on which an anode active material layer is formed may be made of all materials used in a conventional electric double layer capacitor or lithium ion battery, for a concrete example, aluminum, stainless steel, titanium, tantalum, niobium, and so on. Among them, aluminum is most preferred, but the material of the anode current collector is not limited thereto. Further, in addition to a foil of the above metal, an etched metal foil, or a material having a hole passing a surface thereof such as expanded metal, punching metal, a net, and foam can be used. It may be preferred that a thickness of the current collector is about 10 to 300 μm.

As a method of manufacturing an anode, there is a method of forming activated carbon into a sheet by a binder and bonding the sheet to a current collector by a conductive adhesive. Further, there is another method of manufacturing an anode by dispersing activated carbon in a binder, applying slurry onto a current collector by a doctor blade method and so on, and drying the applied slurry. All of these methods are preferred to be applied to the present invention, and a method of manufacturing an anode is not particularly limited.

Further, the cathode in accordance with the present invention may be manufactured by using a material including lithium metal as an active material and applying the material. At this time, for example, the material including lithium metal may be a Li/AI alloy and so on. Further, a sheet cathode may be obtained by rolling a lithium metal plate and a cathode current collector.

The cathode current collector may be made of one or more selected from a group consisting of stainless steel, copper, nickel, and alloys thereof. Among them, copper is most preferred. Further, in addition to a foil of the above metal, an etched metal foil or a material having a hole passing a surface thereof such as expanded metal, punching metal, a net, and foam can be used. It may be preferred that a thickness of the current collector is about 10 to 300 μm.

The cathode in accordance with the present invention may be manufactured by applying the cathode active material on a current collector, a cathode sheet may be obtained by rolling a lithium metal plate and a copper foil current collector, and a method of manufacturing a cathode is not particularly limited thereto.

The lithium ion capacitor in accordance with the present invention has a structure in which the cathode and the anode face each other with the hybrid solid electrolyte membrane interposed therebetween. In this structure, the hybrid solid electrolyte membrane may also play a role of a separator.

Accordingly, in case of using the hybrid solid electrolyte membrane in accordance with the present invention, it may not be required to include an additional separator.

Further, a general separator may be selectively used with the hybrid solid electrolyte membrane. For example, this separator may be a polyolefin polymer separator such as polyethylene and polypropylene; polyester nonwoven; a polyacrylonitrile porous separator; a poly(vinylidene fluoride) hexafluoropropane copolymer porous separator; a cellulose porous separator; kraft paper or rayon fiber, and so on, and the type of separator is not particularly limited if the separator is generally used in the field of batteries and capacitors.

A lithium ion capacitor in accordance with an embodiment of the present invention may include an anode including activated carbon as an active material layer; a cathode including a material including lithium metal as an active material layer; and a hybrid solid electrolyte membrane including a lithium electrolyte salt, an organic polymer, and an inorganic material.

The lithium ion capacitor has a structure in which the anode including activated carbon as an active material layer and the cathode including a material including lithium metal as an active material layer face each other with the hybrid solid electrolyte membrane interposed therebetween. In this capacitor structure, the hybrid solid electrolyte membrane of the present invention can also play a role of a separator. Accordingly, it may not be required to include an additional separator, but a separator may be selectively included.

As the present invention, an electrolyte is manufactured into an organic/inorganic hybrid solid electrolyte membrane including a lithium electrolyte salt, an organic polymer, and an inorganic material. When the organic/inorganic hybrid solid electrolyte membrane is applied to a lithium ion capacitor, the hybrid solid electrolyte membrane may be formed so that an anode and a cathode face each other. Accordingly, it is possible to overcome problems due to leakage of an electrolyte caused by using a conventional liquid electrolyte and problems due to deposition of lithium ions on the cathode.

Further, since the organic/inorganic hybrid solid electrolyte membrane also performs a role of a separator, it is possible to simplify complexity of processes due to addition of a separator and to expect a cost reduction effect as well.

Hereinafter, the present invention will be described in detail in accordance with embodiments as follows. The embodiments of the present invention are provided to fully explain the invention to those skilled in the art. The following embodiments may be modified into various different forms. The scope of the present invention should not be construed as limited to the following embodiments. Preferably, these embodiments are provided in a way that makes the disclosure in the specification thorough and perfect and fully conveys the spirit of the present invention to those skilled in the art.

### First Embodiment

Manufacture of a cell is all performed in an argon glove box with a dew point of less than −60° C.

### (1) Manufacture of an Anode

Activated carbon with a specific surface area of about 2200 m²/g, which is obtained by a steam activation method, is used as an anode active material. Activated carbon powder, acetylene black, and polyvinylidene fluoride are mixed to have a weight ratio of 80:10:10, respectively and then stirred and mixed in N-methyl pyrrodidone, a solvent, to obtain slurry. The slurry is applied onto an aluminum foil with a thickness of 20 μm by a doctor blade method and temporarily dried, and the aluminum foil is cut to have an electrode size of 10 cm×10 cm. Before assembly of a cell, the anode is dried at 120° C. for 10 hours in vacuum.

### (2) Manufacture of a Cathode

A cathode sheet is obtained by rolling a lithium metal plate and a copper foil current collector.

### (3) Manufacture of a Hybrid Solid Electrolyte Membrane

An organic/inorganic hybrid solid electrolyte membrane is obtained by applying a mixture including a lithium electrolyte salt (LiCF₃SO₃) 15 wt %, an organic polymer (polyethylene oxide with a weight average molecular weight of 1,000,000) 45 wt %, and an inorganic material (Li₂S—P₂S₅) 40 wt % on Li metal.

(4) assembly of a Lithium Ion Capacitor Storage Device

A unit is formed by disposing the anode and the cathode to face each other with the organic/inorganic hybrid solid electrolyte membrane interposed therebetween. A lithium ion capacitor storage device is manufactured by welding aluminum on the anode and nickel on the cathode. The lithium ion capacitor storage device can be assembled in both laminated and winding forms.

### Experimental Example

The lithium ion capacitor storage device was charged to 3.8 V for 900 seconds with constant current and voltage and discharged to 2.0 V for 10 seconds with a constant current. The lithium ion capacitor storage device was repeatedly charged and discharged 10 times under the same conditions again.

It was verified that the lithium ion capacitor storage device of the present invention can be charged and discharged to 3.8 V to 2.0 V and manufactured without pre-doping of lithium ions as a solid electrode membrane.

In accordance with an embodiment of the present invention, it is possible to overcome damage of a separator and failure of a capacitor due to deposition of lithium ions on a cathode by using a hybrid solid electrolyte membrane including a lithium electrolyte salt, an organic polymer, and an inorganic material in a lithium ion capacitor.

Further, it is possible to simplify manufacturing processes of a lithium capacitor storage device without a pre-doping process by using activated carbon as an active material of an anode and lithium metal and an alloy thereof as an active material of a cathode and using a hybrid solid electrolyte membrane.

Further, since a hybrid solid electrolyte membrane in accordance with the present invention can also perform a role of a separator, it is possible to achieve process simplification and cost reduction without an additional separator.

What is claimed is:

1. A hybrid solid electrolyte membrane comprising: a lithium electrolyte salt, an organic polymer, and an inorganic material.

2. The hybrid solid electrolyte membrane according to claim 1, wherein the lithium electrolyte salt is one or more selected from a group consisting of LiN(CF₃SO₂)₂, LiCF₃SO₃, LiPF₆, LiBF₄, and LiClO₄.

3. The hybrid solid electrolyte membrane according to claim 1, wherein the organic polymer is one or more selected from a group consisting of oxygen atom-containing organic compounds with a weight average molecular weight of 100,000 to 5,000,000.

4. The hybrid solid electrolyte membrane according to claim 1, wherein the inorganic material is an oxide or an sulfide of one or more elements selected from a group consisting of lithium (Li), phosphorous (P), silicon (Si), titanium (Ti), zirconium (Zr), aluminum (Al), calcium (Ca), and magnesium (Mg), and a mixture thereof.

5. A method of manufacturing a hybrid solid electrolyte membrane comprising: applying a mixture including a lithium electrolyte salt, an organic polymer, and an inorganic material on one or both surfaces of metal.

6. The method of manufacturing a hybrid solid electrolyte membrane according to claim 5, wherein the metal is one or more selected from a group consisting of stainless steel, copper, nickel, and alloys thereof.

7. The method of manufacturing a hybrid solid electrolyte membrane according to claim 5, wherein the mixture includes the lithium electrolyte salt 5 to 25 wt %, the organic polymer 35 to 55 wt %, and the inorganic material 30 to 50 wt %.

8. A lithium ion capacitor comprising:
an anode;
a cathode; and
a hybrid solid electrolyte membrane including a lithium electrolyte salt, an organic polymer, and an inorganic material.

9. The lithium ion capacitor according to claim 8, wherein the anode includes active carbon as an active material.

10. The lithium ion capacitor according to claim 8, wherein the cathode includes a material including lithium metal as an active material.

11. A lithium ion capacitor comprising:
an anode including activated carbon as an active material layer;
a cathode including a material including lithium metal as an active material layer; and
a hybrid solid electrolyte membrane including a lithium electrolyte salt, an organic polymer, and an inorganic material.

12. The lithium ion capacitor according to claim 8, wherein an additional separator is not included.

13. The lithium ion capacitor according to claim 11, wherein an additional separator is not included.

14. The lithium ion capacitor according to claim 8, wherein the hybrid solid electrolyte membrane is capable of being used as a separator.

15. The lithium ion capacitor according to claim 11, wherein the hybrid solid electrolyte membrane is capable of being used as a separator.
